(19) United States
(12) Patent Application Publication
(10) Pub. No.: US 2006/0052264 A1
(43) Pub. Date: Mar. 9, 2006

(54) Hard surface cleaning and disinfecting compositions

(76) Inventor: Robert Zhong Lu, Montvale, NJ (US)

Correspondence Address: NORRIS, MCLAUGHLIN & MARCUS, 875 THIRD AVE, 18TH FLOOR, NEW YORK, NY, 10022, US

(21) Appl. No.: 10/530,427

(22) PCT Filed: Oct. 10, 2003
(86) PCT No.: PCT/GB03/04411

§ 371 Date: Apr. 5, 2005

(30) Foreign Application Priority Data
Oct. 12, 2002 (GB) 0223846.7

(51) Int. Cl. C11D 3/20

(52) U.S. Cl. 510/238

(57) ABSTRACT

Aqueous compositions comprising a synergistic combination of sodium hydroxide, sodium dodecylbenzene sulfonate, and either benzyl alcohol or propylene glycol phenyl ether are described. The compositions provide good germicidal efficacy against both Gram positive and Gram negative bacteria on hard surfaces and the like. Processes for the sanitization of hard surfaces wherein the presence of Gram positive and/or Gram negative bacteria is suspected are also disclosed.

The present invention relates to disinfectant compositions based on a synergistic combination of an alkali metal hydroxide, an anionic surfactant, a solvent selected from an alcohol, glycol ether and mixtures thereof, and a soap. These compositions find use in variety of applications for the sanitization (or disinfection) and/or cleaning of hard surfaces and articles on which the presence of bacteria is suspected.

There remains a continuing need in the art for further improved formulations that provide a useful germicidal effect, especially non-quaternary-based anti-microbial agents useful in the sanitization of hard surfaces and the like.

Accordingly it is an object of the invention to provide a cleaning and/or disinfectant composition that is particularly useful in the disinfection of surfaces where the presence of Gram positive type pathogenic bacteria such as Staphylococcus aureus, and/or the presence of Gram negative type pathogenic bacteria such as Salmonella cholerasuis is suspected.

Accordingly, a further object of the invention is a process for the cleaning and/or disinfection of surfaces, especially hard surfaces, wherein the presence of Gram positive type pathogenic bacteria and/or Gram negative type pathogenic bacteria are suspected.

It is a still further object of the invention to provide a fast acting, liquid disinfectant composition is useful for the cleaning and/or disinfection of surfaces, especially hard surfaces wherein the presence of both Gram positive type pathogenic bacteria and Gram negative type pathogenic bacteria is suspected.

In one aspect, the present invention relates to an aqueous hard surface cleaning and/or sanitizing composition which comprises an anionic surfactant; an alkali metal hydroxide; a soap; a solvent selected from alcohol, glycol ether, or mixture thereof; and water.

The anionic surfactant is generally present in the composition of the present invention in an amount of from about 0.01 to about 20 wt %. The alkali metal hydroxide is generally present in the composition of the present invention in an amount of from about 0.01 to 2 wt %. The soap is generally present in the composition of the present invention in an amount of from about 0 to about 20 wt %. The solvent is generally present in the composition of the present invention in an amount of from about 0.1 to about 10 wt %.

In accordance with the present invention, there has been found an inventive combination of an alkali metal hydroxide (e.g. and not limited to, sodium hydroxide and potassium hydroxide) and an alcohol, glycol ether, or mixture thereof (e.g. and not limited to, respectively, benzyl alcohol, propylene glycol phenyl ether, or a combination of benzyl alcohol and propylene glycol phenyl ether) provides good broad spectrum germicidal efficacy against both Gram positive and Gram negative bacteria on hard surfaces and the like, and that can be readily added to form part of an aqueous, dilutable composition.

The compositions of the present invention can be used on hard surfaces as is (neat) or can be diluted for example from 1:1 to about 1:1000 (composition:water), for example 1:2; 1:4; and 1:8 (composition:water).

The present invention relates to an aqueous hard surface cleaning and/or sanitizing composition which comprises:

an anionic surfactant;

an alkali metal hydroxide;

soap;

a solvent selected from alcohol, glycol ether, or mixtures thereof;

and water.

The compositions may also include further optional additives.

The anionic surfactant is generally present in the composition of the present invention in an amount of from about 0.01 to about 20 wt %. The alkali metal hydroxide is generally present in the composition of the present invention in an amount of from about 0.01 to 2 wt %. The soap is generally present in the composition of the present invention in an amount of from about 0 to about 20 wt %. The solvent is generally present in the composition of the present invention in an amount of from about 0.1 to about 10 wt %.

In accordance with the present invention, there has been found an inventive combination of an alkali metal hydroxide (e.g. and not limited to, sodium hydroxide and potassium hydroxide) and an alcohol, glycol ether, or mixture thereof (e.g. and not limited to, respectively, benzyl alcohol, propylene glycol phenyl ether, or a combination of benzyl alcohol and propylene glycol phenyl ether) provides good broad spectrum germicidal efficacy against both Gram positive and Gram negative bacteria on hard surfaces and the like, and that can be readily added to form part of an aqueous, dilutable composition.

The compositions of the present invention can be used on hard surfaces as is (neat) or can be diluted for example from 1:1 to about 1:1000 (composition:water), for example, 1:2; 1:4; and 1:8 (composition:water).

Desirably the total amount of a solvent selected from alcohol (e.g. and not limited to benzyl alcohol), glycol ether (e.g. and not limited to propylene glycol phenyl ether), or combination thereof (e.g. and not limited to benzyl alcohol and propylene glycol phenyl ether) present in the composition is from about 0.1 to about 10 wt %, more desirably in an amount of from about 0.5 to about 8% by weight. While increasing the amount of alcohol or ether generally results in an increase in antimicrobial efficacy, cost and solubility place practical constraints on the levels that can be used.

Desirably the alkali metal hydroxide (e.g. not limited to sodium hydroxide) is present in an amount of from about 0.01 to about 2 wt %, more preferably is present in an amount of from about 0.05 to about 1 wt %. In general, increasing the amount of alkali metal hydroxide was found to sharply increase the anti-microbial efficacy of the compositions; however, eye and/or skin irritation concerns may mandate that the amount of sodium hydroxide present be limited as indicated above.

The anionic surfactants include, for example, alkali metal salts, ammonium salts, amine salts, or aminoalcohol salts of one or more of the following compounds (linear and secondary): alcohol sulfates and sulfonates, alcohol phosphates and phosphonates, alkyl sulfates, alkyl ether sulfates, sulfate esters of an alkylphenoxy polyoxyethylene ethanol, alkyl monoglyceride sulfates, alkyl sulfonates, olefin sulfonates, paraffin sulfonates, beta-alkoxy alkane sulfonates, alkylamidoether sulfates, alkylaryl polyether sulfates, monoglyceride sulfates, alkyl ether sulfonates, ethoxylated alkyl sulfonates, alkylaryl sulfonates, alkyl benzene sulfonates, alkylamide sulfonates, alkyl monoglyceride sulfonates, alkyl carboxylates, alkyl sulfoacetates, alkyl ether carboxylates, alkyl alkoxy carboxylates having 1 to 5 moles of ethylene oxide, alkyl sulfosuccinates, alkyl ether sulfosuccinates, alkylamide sulfosuccinates, alkyl sulfosuccinamates, octoxynol or nonoxynol phosphates, alkyl phosphates, alkyl ether phosphates, taurates, N-acyl taurates, fatty taurides, fatty acid amide polyoxyethylene sulfates, isethionates, acyl isethionates, and sarcosinates, acyl sarcosinates, or mixtures thereof. Generally, the alkyl or acyl radical in these various compounds comprise a carbon chain containing 12 to 20 carbon atoms.

Examples of the foregoing anionic surfactants are available under the following tradenames: RHODAPON, STEPANOL, HOSTAPUR, SURFINE, SANDOPAN, NEODOX, BIOSOFT, and AVANEL. An example of a desirable anionic surfactant is sodium dodecylbenzene sulfonate (e.g., Bio-Soft D40®, Stepan Company, Northfield, Ill.). The anionic surfactant is present in an amount of from about 0.01 to about 30 wt %, more preferably from about 0.5 to about 10 wt %. The quantity of anionic surfactant was found to have little effect on antimicrobial activity.

Soap is generally added to the compositions as well, as a blooming agent. Soap is desirably present in the composition in an amount of from 0 to about 20 wt %. In general, lower soap concentrations improve antimicrobial efficacy and reduce cost.

The soap component includes ordinary alkali metal soaps such as the sodium, potassium, ammonium and alkanol-ammonium salts of higher fatty acids containing from about 8 to about 24 carbon atoms and preferably from about 10 to about 20 carbon atoms. Suitable fatty acids can be obtained from natural sources such as, for instance, plant or animal esters (e.g., palm oil, coconut oil, babassu oil, soybean oil, castor oil, tallow, whale and fish oils, grease, lard, and mixtures thereof). The fatty acids also can be synthetically prepared (e.g., by the oxidation of petroleum, or by the Fischer-Tropsch process). Resin acids are suitable such as rosin and those resin acids in tall oil. Naphthenic acids are also suitable. Sodium and potassium soaps can be made by direct saponification of the fats and oils or by the neutralization of the free fatty acids which are prepared in a separate manufacturing process. Particularly useful is the sodium or potassium salt of the mixtures of fatty acids derived from castor oil, i.e., sodium or potassium castor oil soap.

A solvent selected from alcohol, glycol ethers, and mixtures thereof is another component of the present invention. Examples include C₁-C₈ alcohols, glycol ethers, and mixtures thereof. Examples of C₁ to C₈ alcohols include ethanol, propanol, isopropanol, hexanol, and benzyl alcohol. Examples of glycol ethers include propylene glycol phenyl ether, propylene glycol methyl ether, dipropylene glycol methyl ether, tripropylene glycol methyl ether, propylene glycol n-propyl ether, diethylene glycol methyl ether, ethylene glycol butyl ether, diethylene glycol methyl ether, and mixtures thereof.

Water is added to the above constituents in order to provide 100% by weight of the composition. The water may be tap water, but is preferably distilled and is most preferably deionized water. If the water is tap water, it is preferably substantially free of any undesirable impurities such as organics or inorganics, especially mineral salts which are present in hard water which may interact with the other components of the inventive compositions.

The results that have been obtained are surprising, as it has been found that 0.3-0.5 wt % sodium hydroxide, when combined with about 5% soap and 3% singular, binary, or ternary surfactant systems (e.g., ethoxylated alcohol, SDS, or sodium dodecylbenzene sulfonate) provided no more than a one log reduction in Staphylococcus. When amine oxide, OBPCP (ortho benzyl parachlorophenol), thymol, or amine was added to the best of the hydroxide/soap/anionic surfactant systems, the results were no better. These compositions, accordingly, do not provide the same type beneficial level of germicidal efficacy achieved with the synergistic combination which only the present inventors have discovered.

The aqueous compositions according to the invention can further include one or more conventional additives including but not limited to: further non-aqueous solvents, chelators, building agents, pH buffering agents, perfumes, perfume carriers, stabilizing agents, coloring agents, hydrotropes, antifoaming agents, as well as one or more nonionic, cationic, anionic, amphoteric or zwitterionic surfactants. Those of ordinary skill in the art will appreciate that one or more of these may be included in any amount which do not undesirably detract from the cleaning and/or antimicrobial activity of the compositions. Such materials are known to the art, including those described in McCutcheon's Emulsifiers and Detergents (Vol. 1), McCutcheon's Functional Materials (Vol. 2), North American Edition, 2001; Kirk-Othmer, Encyclopedia of Chemical Technology, 3rd Ed., Vol. 22, the contents of which are herein incorporated by reference. For any particular composition, such optional ingredients should be compatible with the other ingredients present.

A particular advantage of the inventive compositions is the fact that in preferred embodiments, they comprise relatively low amounts of volatile organic constituents. Of increasing interest are the provision of products which satisfy the stringent requirements of the United States Environmental Protection Agency (EPA) for low volatile organic content (“low VOC”) products. According to specific preferred embodiments, the ready-to-use disinfecting compositions provided herein meet such stringent requirements. The inventive compositions may be used in a wide variety of disinfecting applications and in a wide variety of environments that can benefit from a disinfecting effect. These applications and environments include usage in the medical sector for the disinfection of instruments and apparatuses, as well as in operating theatres for disinfection or decontamination of the facilities and fixtures therein. Hospitals, clinics, examining rooms, and other environments associated with the provision of healthcare services, in which the presence of Gram positive bacteria and/or Gram negative bacteria are suspected is also expressly contemplated. The use of the compositions for the disinfection or decontamination of hospital environments specifically includes cleaning of lavatories and lavatory fixtures. Such environments are to be understood to include not only the surfaces of walls, ceilings and floors, but to specifically include other surfaces such as the surfaces of various health care apparatus which may be found in such environments wherein healthcare surfaces are provided. The use of the inventive compositions provides an effective and simple to use method for the disinfection of such environments.

The inventive compositions are particularly to be understood to include hard surfaces. By way of non-limiting example, hard surfaces suitable for disinfection with the compositions of this invention include surfaces composed of refractory materials such as: glazed and unglazed tile, porcelain, ceramics as well as stone including marble, granite, and other stone surfaces; glass; metals; plastics (e.g. polyester, vinyl; Fiberglas®, Formica®, Corian®); and other hard surfaces known to the industry. Hard surfaces include lavatory fixtures such as shower stalls, bathtubs, and bathing appliances (racks, curtains, shower doors, shower bars) toilets, bidets, wall and flooring surfaces, especially those that include refractory materials and the like. Other examples of hard surfaces include those associated with kitchen environments and other environments associated with food preparation, including cabinets and countertop surfaces as well as walls and floor surfaces especially those which include refractory materials, plastics, Fiberglas®, Formica®, Corian®, and stone.

The compositions according to the invention can be desirably provided as a ready-to-use product in a manually operated spray-dispensing container. Such a typical container is generally made of synthetic polymer plastic material such as polyethylene, polypropylene, polyvinyl chloride, or the like, and includes a spray nozzle, a dip tube, and associated pump dispensing parts, and is thus ideally suited for use in a consumer “spray and wipe” application. In such an application, the consumer generally applies an effective amount of the composition using the pump, and, a short time thereafter, wipes off the treated area with a rag, towel, sponge, or other material. In this manner, disinfection of the treated surface can be achieved.

In a yet a further embodiment, the compositions according to the invention can be formulated so that they can be used in conjunction with an “aerosol”-type product, wherein a composition is discharged from a pressurized aerosol container. Propellants which may be used are well known and conventional in the art and include, for example, a hydrocarbon, of from 1 to 10 carbon atoms, such as n-propane, n-butane, isobutane, n-pentane, isopentane, and mixtures thereof; dimethyl ether and blends thereof as well as individual or mixtures of chloro-, chlorofluoro- and/or fluorohydrocarbons- and/or hydrochlorofluorocarbons (HCFCs). Useful commercially available compositions include A-70 (Aerosol compositions with a vapor pressure of 70 psig available from companies such as Diversified and Aeropress) and Dymel 152a (1,1-difluoroethane from DuPont). Compressed gases such as carbon dioxide, compressed air, nitrogen, and possibly dense or supercritical fluids may also be used. In such an application, a composition according to the invention is dispensed by activating the release nozzle of said aerosol type container onto a surface in need of disinfection, and generally in accordance with a manner as above-described is removed with the use of a rag, towel, or sponge, or other material.

The compositions of the present invention can also be provided as a concentrated solution which is then added to a larger amount of water, in amounts of from about 1:1 to 1:1000 (composition:water) to then form a cleaning solution. The formed cleaning solution can then be applied to a surface by using a mop, rag, etc.

The compositions according to the invention provide at least a 2 log₁₀ reduction used as neat for broad spectrum efficacy and at least a 4 log₁₀ reduction in a 1:4 aqueous dilution using a Biomek assay against Salmonella choleraesuis (Gram negative type pathogenic bacteria) at a fifteen second contact time. Preferably, the preferred embodiments of the inventive compositions are effective to provide at least a 4, 5, 6 or greater log₁₀ reduction against both Salmonella choleraesuis and Staphylococcus aureus. In further preferred embodiments, compositions of the present invention can be used as disinfectants when used neat and acceptable cleaning products when used at 1:10 to 1:100 dilutions (when diluted, blooming occurs).

One skilled in the art will recognize that modifications can be made in the present invention without deviating from the spirit or scope of the invention. The invention is illustrated further by the following examples, which are not to be construed as limiting the invention or scope of the specific procedures described herein.

### EXAMPLES

For purposes of illustration of the present inventive compositions, various formulations were produced and are reported below.

Into a suitably sized vessel, a measured amount of room temperature water (˜20° C.) was provided after which measured amounts of remaining constituents were added. All of the remaining constituents were similarly supplied at room temperature; mixing of the constituents was achieved by the use of a magnetic stirrer apparatus. Mixing, which generally lasted several minutes, and maintained until the particular exemplary formulation appeared to be homogeneous.

It is to be noted that the constituents may be added in any order, but it is preferred that water be the initial constituent provided to a mixing vessel or apparatus as it is the major constituent and addition of the further constituents thereto is convenient.

Comparative formulations are shown in Table 1 and inventive formulations subject to the present application are shown in Tables 2 and 3. The quantities of composition components are given as percentages by weight (wt %). The antimicrobial efficacies are given as log10 reductions based on an initial 8 or 9 log10 titer (as indicated) of the respective bacteria. Unless otherwise noted, the components in Tables 2 and 3 are at 100% active.

TABLE 1

| | C1 | C2 | C3 | C4 | C5 | C6 | C7 | C8 | C9 |
|---|---|---|---|---|---|---|---|---|---|
| Ethoxylate* | 1.5 | | 1.0 | 1.0 | 1.0 | | 1.5 | | 1.0 |
| Sulfonate** | 1.5 | | 1.0 | 1.0 | 1.0 | 1.5 | | 3.0 | 1.0 |
| Sulfate*** | | 3.0 | 1.0 | 1.0 | 1.0 | 1.5 | 1.5 | | 1.0 |
| Soap (40%) | K | Na | K | K | K | Na | K | Na | Na |
| NaOH | 0.4 | 0.4 | 0.4 | 0.3 | 0.5 | 0.4 | 0.4 | 0.4 | 0.5 |
| pH | 13.14 | 13.10 | 13.15 | 13.04 | 13.22 | 13.09 | 13.13 | 13.08 | 13.16 |
| Water | q.s. | q.s. | q.s. | q.s. | q.s. | q.s. | q.s. | q.s. | q.s. |

# of Log10 reduction (initial = 9 log titer)

| Biomek | | | | | | | | | |
|---|---|---|---|---|---|---|---|---|---|
| S. cholerasuis | 8.75 | 8.75 | 8.75 | 8.75 | 8.75 | 8.75 | 8.75 | 8.75 | 8.75 |
| S. aureus | 0.63 | 0.70 | 0.00 | 0.45 | 0.61 | 0.61 | 0.40 | 0.80 | 0.45 |
| Bloom (light trans. | 11.4 | 10.7 | 9.6 | 9.4 | 10.5 | 10.7 | 8.3 | 7.3 | 5.3 |
| %; 1:100 dilution | | | | | | | | | |
| Cleaning (% soil | 10.99 | 5.76 | 5.59 | 7.85 | 5.33 | 9.24 | 19.94 | 9.41 | 7.87 |
| removal; 1:100 | | | | | | | | | |
| dilution) | | | | | | | | | |
| | C10 | C11 | C12 | C13 | C14 | C15 | C16 | C17 | C18 |
| Ethoxylate | 1.5 | | | 1.0 | 1.0 | 3.0 | 1.5 | 3.0 | |
| Sulfonate | | 1.5 | | 1.0 | 1.0 | | 1.5 | | 3.0 |
| Sulfate | 1.5 | 1.5 | 3.0 | 1.0 | 1.0 | | | | |
| Soap (40%) | Na | K | K | Na | Na | K | Na | Na | K |
| NaOH | 0.4 | 0.4 | 0.4 | 0.4 | 0.3 | 0.4 | 0.4 | 0.4 | 0.4 |
| pH | 13.09 | 13.09 | 13.10 | 13.07 | 12.96 | 13.13 | 13.08 | 13.09 | 13.08 |
| Water | q.s. | q.s. | q.s. | q.s. | q.s. | q.s. | q.s. | q.s. | q.s. |

# of Log10 reduction (initial = 9 log titer)

| | | | | | | | | | |
|---|---|---|---|---|---|---|---|---|---|
| Biomek | | | | | | | | | |
| S. cholerasuis | 8.75 | 8.75 | 8.75 | 8.75 | 8.75 | 8.75 | 8.75 | 8.75 | 8.75 |
| S. aureus | 0.45 | 0.91 | 0.61 | 0.20 | 0.08 | 0.20 | 0.30 | 0.20 | 1.00 |
| Bloom (light trans. | 4.5 | 5.7 | 4.6 | 5.0 | 5.6 | 5.9 | 7.6 | 4.9 | 4.4 |
| %; 1:100 dilution | | | | | | | | | |
| Cleaning (% soil | 11.67 | 6.68 | 7.28 | 14.46 | 6.05 | 16.08 | 10.51 | 15.94 | 3.98 |
| removal; 1:100 | | | | | | | | | |
| dilution) | | | | | | | | | |

*alcohol ethoxylate (Genapol 26-L-60; Clariant)
**sodium dodecylbenzene sulfonate (Bio-Soft D40; Stepan)
***sodium lauryl sulfate (Stepanol WAC; Stepan)

TABLE 2

| | E1 | E2 | E3 | E4 | E5 | E6 | E7 | E8 | E9 |
|---|---|---|---|---|---|---|---|---|---|
| Bio-soft D40 ® | 3.00 | 3.00 | 2.00 | 3.00 | 2.00 | 2.50 | 3.00 | 3.00 | 3.00 |
| (40%) | | | | | | | | | |
| Na Soap (40%) | 8.00 | 8.00 | 12.00 | 12.00 | 8.00 | 10.00 | 8.00 | 12.00 | 12.00 |
| NaOH (25%) | 0.20 | 0.40 | 0.20 | 0.40 | 0.20 | 0.30 | 0.40 | 0.20 | 0.40 |
| Benzyl Alcohol | 2.00 | 2.00 | 1.00 | 2.00 | 2.00 | 1.50 | 2.00 | 2.00 | 1.00 |
| pH | 12.78 | 13.07 | 12.80 | 13.06 | 12.78 | 12.96 | 13.03 | 12.84 | 13.07 |
| Water | q.s. | q.s. | q.s. | q.s. | q.s. | q.s. | q.s. | q.s. | q.s. |

# of Log10 reduction (initial = 9 log titer)

| Biomek | | | | | | | | | |
|---|---|---|---|---|---|---|---|---|---|
| S. cholerasuis | 7.56 | 7.56 | 7.56 | 7.56 | 7.56 | 7.56 | 7.56 | 7.64 | 7.56 |
| S. aureus | 5.01 | 6.14 | 2.11 | 6.21 | 3.94 | 4.19 | 5.90 | 4.34 | 4.77 |
| Bloom (light trans. | | | | | | | | 6.8 | |
| %; 1:100 dilution | | | | | | | | | |
| | E10 | E11 | E12 | E13 | E14 | E15 | E16 | E17 | E18 |
| Bio-soft D40 ® | 2.00 | 3.00 | 2.00 | 2.50 | 2.00 | 2.00 | 3.00 | 2.00 | 3.00 |
| (40%) | | | | | | | | | |
| Na Soap (40%) | 8.00 | 8.00 | 8.00 | 10.00 | 12.00 | 12.00 | 12.00 | 12.00 | 8.00 |
| NaOH (25%) | 0.40 | 0.20 | 0.20 | 0.30 | 0.20 | 0.40 | 0.20 | 0.40 | 0.40 |
| Benzyl Alcohol | 1.00 | 1.00 | 1.00 | 1.50 | 2.00 | 1.00 | 1.00 | 2.00 | 1.00 |
| pH | 13.04 | 12.76 | 12.75 | 12.93 | 12.78 | 13.05 | 12.75 | 13.04 | 13.03 |
| Water | q.s. | q.s. | q.s. | q.s. | q.s. | q.s. | q.s. | q.s. | q.s. |

# of Log10 reduction (initial = 9 log titer)

| | | | | | | | | | |
|---|---|---|---|---|---|---|---|---|---|
| Biomek | | | | | | | | | |
| S. cholerasuis | 7.56 | 7.56 | 7.56 | 7.56 | 7.64 | 7.56 | 7.64 | 7.56 | 7.56 |
| S. aureus | 4.08 | 4.01 | 2.71 | 4.92 | 3.31 | 4.08 | 3.15 | 5.84 | 5.77 |
| Bloom (light trans. | | | | | 9.5 | | 7.3 | | 8.7 |
| %; 1:100 dilution | | | | | | | | | |

TABLE 3

| | E19 | E19 | E19 | E20 | E21 | E21 | E21 | E21 |
|---|---|---|---|---|---|---|---|---|
| | Neat | 1:2 | 1:4 | Neat | Neat | 1:2 | 1:4 | 1:10 |
| Bio-soft | | 7.50 | | | 7.50 | 17.50 | | |
| D40 ® (40%) | | | | | | | | |
| Na Soap (40%) | 3.50 | | | 3.50 | 4.00 | | | |
| NaOH (25%) | 1.60 | | | 1.60 | 1.60 | | | |
| Benzyl Alcohol | | | | | | | | |
| Dowanol PPH | 2.00 | | | 1.00 | 4.00 | | | |
| Water | q.s. | | | q.s. | q.s. | | | |

# of Log10 reduction (initial = 9 log titer)

| Biomek | | | | | | | | |
|---|---|---|---|---|---|---|---|---|
| S. cholerasuis | 7.74 | 7.74 | 4.45 | 5.04 | 7.54 | 4.59 | 1.20 | n/a |
| S. aureus | 5.20 | 2.02 | 0.94 | 4.82 | 7.63 | 4.00 | 0.74 | n/a |
| Bloom | 17.8 | | | 30.30 | 3.30 | | | |
| (light trans. %; | | | | | | | | |
| 1:100 dilution | | | | | | | | |
| Cleaning (% | n/a | n/a | 18.67 | n/a | 85.58 | n/a | 27.72 | 23.47 |
| soil removal; | | | | | | | | |
| 1:100 | | | | | | | | |
| dilution) | | | | | | | | |
| | E22 | E22 | E22 | E22 | E23 | E23 | E23 | E23 |
| | Neat | 1:2 | 1:4 | 1:8 | Neat | 1:2 | 1:4 | 1:8 |
| Bio-soft | 17.50 | | | | 12.50 | | | |
| D40 ® (40%) | | | | | | | | |
| Na Soap (40%) | | | | | 4.00 | | | |
| NaOH (25%) | 1.60 | | | | 1.60 | | | |
| Benzyl Alcohol | 3.00 | | | | 3.00 | | | |
| Dowanol PPH | | | | | | | | |
| Water | q.s. | | | | q.s. | | | |

# of Log10 reduction (initial = 9 log titer)

| | | | | | | | | |
|---|---|---|---|---|---|---|---|---|
| Biomek | | | | | | | | |
| S. cholerasuis | 7.74 | 7.74 | 3.65 | 0.58 | 7.74 | 7.74 | 3.76 | 0.31 |
| S. aureus | 7.37 | 5.17 | 2.23 | n/a | 7.40 | 3.77 | 1.46 | n/a |
| Bloom | | | | | 2.80 | | | |
| (light trans. %; | | | | | | | | |
| 1:100 dilution | | | | | | | | |
| Cleaning (% | n/a | n/a | n/a | n/a | n/a | n/a | n/a | n/a |
| soil removal; | | | | | | | | |
| 1:100 | | | | | | | | |
| dilution) | | | | | | | | |

| | E24 | E24 | E24 | E24 |
|---|---|---|---|---|
| | Neat | 1:2 | 1:4 | 1:64 |
| Bio-soft D40 ® (40%) | 7.50 | | | |
| Na Soap (40%) | 3.50 | | | |
| NaOH (25%) | 1.60 | | | |
| Benzyl Alcohol | 1.60 | | | |
| Dowanol PPH | | | | |
| Water | q.s. | q.s. | q.s. | q.s. |

# of Log10 reduction (initial = 9 log titer)

| | | | | |
|---|---|---|---|---|
| Biomek | | | | |
| S. cholerasuis | 7.74 | 7.68 | 1.78 | n/a |
| S. aureus | 5.23 | 1.68 | 0.66 | n/a |
| Bloom (light trans. | 20.50 | | | |
| %; 1:100 dilution | | | | |
| Cleaning (% soil | 20.50 | n/a | n/a | n/a |
| removal; 1:100 | | | | |
| dilution) | | | | |

Na Soap is sodium castor oil soap (40% active)
Dowanol PPH is propylene glycol phenyl ether (Dow Chemical Co.)
Biosoft D-40 is a sodium linear alkylate sulfonate (40% wt. actives) (Stepan Co.)

Tables 4 to 6 show a variety of control and other non-inventive (unless otherwise indicated) compositions that correspond to the above discussion regarding other materials being added to the composition (e.g., OBPCP, thymol, etc) that the results were no better.

TABLE 4

| | C19 | C20 | C21 | C22 |
|---|---|---|---|---|
| Formula | % | % | % | % |
| Bio-soft D40 (40%) | 7.50 | | 7.50 | 7.50 |
| Genapol 26-L-60 | | 3.00 | | |
| Na Soap (40%) | 11.00 | 11.00 | 3.50 | 3.50 |
| NaOH (25%) | 1.60 | 1.60 | | |
| Benzyl alcohol | | 1.00 | | 1.00 |
| Dowanol PPH | | | 1.00 | |
| DI water | q.s. | q.s. | q.s. | q.s. |
| Log₁₀ Reduction (Salmonella) | n/a | n/a | 0.00 | 0.00 |
| Log₁₀ Reduction (Staph.) | 1.36 | 2.60 | 1.98 | 2.48 |

TABLE 5

| | C23 | C24 | C25 | C26 | C27 |
|---|---|---|---|---|---|
| Formula | % | % | % | % | % |
| Genapol 26-L-60 | 3.00 | 3.00 | 3.00 | 3.00 | 3.00 |
| Na Soap (40%) | 12.00 | 12.00 | 12.00 | 12.00 | 12.00 |
| NaOH | 0.40 | 0.40 | 0.40 | 0.40 | 0.40 |
| Benzyl alcohol | 1.00 | — | — | — | — |
| Ammonyx LO | — | 1.30 | — | — | — |
| Preventol BP | — | — | 0.19 | — | — |
| Thymol (crystal) | — | — | — | 0.15 | — |
| Duomeen C | — | — | — | — | 0.04 |
| Log₁₀ Reduction (Staph.) | 0.81 | 0.63 | 0.46 | 0.29 | 0.24 |

Genapol 26-L-60 is a non-ionic surfactant (Clariant; linear C₁₂-C₁₆ alcohol ethoxylate with an average of 7.3 ethylene oxide groups per molecule.
Ammonyx LO is laurylamine oxide (Stepan)

TABLE 6

| | E25 | C28 | C29 | E1 | C30 | C31 |
|---|---|---|---|---|---|---|
| Formula | % | % | % | % | % | % |
| Bio-soft D40 (40%) | 7.50 | 7.50 | 7.50 | 7.50 | 7.50 | 7.50 |
| Na Soap | 8.00 | 8.00 | 8.00 | 8.00 | 8.00 | 8.00 |
| NaOH | 0.10 | 0.10 | 0.10 | 0.20 | 0.20 | 0.20 |
| Benzyl alcohol | 2.00 | | | 2.00 | | |
| Hexyl Carbitol | | 2.00 | | | 2.00 | |
| Preventol BP | | | 0.19 | | | 0.19 |
| Na₂CO₃ | | | 0.10 | | | 0.10 |
| Log Reduction (Staph) | 2.92 | 1.76 | 1.78 | 5.04 | 2.00 | 2.41 |

Preventol BP is ortho-benzyl-parachlorophenol (Bayer)
Duomeen C is N-coco-1,3-diaminopropane
Hexyl Carbitol is diethylene glycol monohexyl ether

Cleaning efficacy was determined by using oily-particulate soil on vinyl tiles under the protocol of ASTM D-4488-89 Annex A5 for particulate soil. Bloom was assessed in cold tap water with a water hardness of about 200 ppm. Comparative compositions and their respective antimicrobial activities at various dilutions, bloom (at 1:100 dilution), and cleaning efficacy (at 1:100 dilution) are indicated in Table 1. For each sample, cleaning efficacy was found to be low, due to the low content of the detergent ingredient.

The experiments were repeated with a second series of 18 inventive compositions (E1-E18). The formulations and respective results are shown in Table 2. Six additional compositions (E19-E24), some having Dowanol PPH®-brand propylene glycol phenyl ether in place of the benzyl alcohol, were also tested. The formations and respective results are shown in Table 3.

The sanitizing efficacy of the inventive compositions were determined as follows:

Comparative formulations described in Table 1 and inventive formulations described in Table 2, were evaluated for antimicrobial efficacy at neat condition, and additional inventive formulations described in Table 3 were evaluated at the indicated dilutions against Salmonella choleraesuis (Gram negative type pathogenic bacteria) and Staphylococcus aureus (Gram positive type pathogenic bacteria). The test was carried out for each of the formulations neat or at dilution of one part of a respective formulation to 2-8 parts of deionized water at 25° C. for a fifteen (15) second contact time. The test protocol followed for each sample was generally as follows.

Several compositions of the present invention were evaluated for antimicrobial activity using the Biomek® 2000 Laboratory Automation Workstation together with the BioWorks Operating System (available from Beckman Coulter Inc., Fullerton, Calif.). The organisms tested were Salmonella cholerasuis and Staphylococcus aureus at a concentration of 9 logs. The Biomek simulates a microbial reduction suspension test. One part of organism suspension (Salmonella cholerasuis or Staphylococcus aureus) is added to 9 parts of each of the samples listed in the above tables (where noted) in an appropriate container. Deionized water (DI H₂O) was used a control. The organism and sample are then mixed thoroughly for 15 seconds. Serial tenfold dilutions are carried out in a neutralizing broth. The diluted samples are then incubated for 24-48 hours at 35-37° C. Thereafter, surviving organisms are quantified and log₁₀ reduction, as a measurement of organism survivors are calculated as follows:
Log10 Reduction=(Log₁₀ Survivors/DI H₂O Control)−(Log10 Survivors/Sample)

For this test with a contact time of 15 second, a Log10 reduction value of 3 or greater against both organisms is a good indication of acceptable performance (i.e., broad spectrum antimicrobial activity). The results of this evaluation are summarized in Tables 1-3, above, as indicated with respect to the particular formulation being evaluated. As may be seen from the results indicated, the inventive formulations of Tables 2 and 3 consistently provided superior antimicrobial performance against both Gram positive and Gram negative pathogenic bacteria. This result is surprising as results provided by the compositions of Table 1 were effective against Salmonella, but not against Staphylococcus. Such superior results are surprising and unexpected.

As may be seen from the results indicated above, the compositions according to the invention provide excellent antimicrobial efficacy of these compositions against known bacteria commonly found in bathroom, kitchen and other environments. While the invention is susceptible of various modifications and alternative forms, it is to be understood that specific embodiments thereof have been shown by way of example and are not intended to limit the invention to the particular forms disclosed; on the contrary, the intention is to cover all modifications, equivalents and alternatives falling within the scope and spirit of the invention as expressed in the appended claims.

1. An aqueous hard surface cleaning and/or sanitizing composition which comprises:
an anionic surfactant;
an alkali metal hydroxide;
soap;
solvent selected from alcohol, glycol ether, or mixture thereof; and
water.

2. The composition according to claim 1 wherein the surfactant is present in an amount of from about 0.01 to about 20 wt. %.

3. The composition according to claim 1 wherein the alkali metal hydroxide is present in an amount of from about 0.01 to about 2 wt. %.

4. The composition according to claim 1 wherein the soap is present in an amount of from about 0 to about 20 wt. %.

5. The composition according to claim 1 wherein the solvent is present in an amount of from about 0.1 to about 10 wt. %.

6. The composition according to claim 1 whererin the solvent is an alcohol or glycol ether.

7. (canceled)

8. The composition according to claim 1 wherein the solvent is a mixture of alcohol and glycol ether.

9. An aqueous hard surface cleaning and/or sanitizing composition which comprises:
0.01-20 wt. % of an anionic surfactant;
0.01-2 wt. % of an alkali metal hydroxide;
0-20 wt % soap;
0.1-10 wt % of a solvent selected from alcohol, glycol ether, or mixture thereof; and
water to 100 wt %.

10. The composition according to claim 9, further comprising 0.1-20 wt % soap.

11. The composition according to claim 10, wherein the solvent is an alcohol.

12. The composition according to claim 10 wherein the alcohol is benzyl alcohol.

13. The composition according to claim 10 wherein the solvent is a glycol ether.

14. The composition according to claim 10 wherein the glycol ether is propylene glycol phenyl ether.

15. The composition according to claim 10 whererin the solvent is a mixture of alcohol and glycol ether.

16. (canceled)

17. (canceled)

18. (canceled)

19. A process for the sanitization of hard surfaces and articles wherein the presence of bacteria is suspected which comprises the process step of:
contacting the surface with a disinfecting effective amount of a composition according to claim 1 for a sufficient time to sanitize said surface.

20. A process for the sanitization of surfaces and articles wherein the presence of bacteria is suspected which comprises the process step of:
contacting the surface with a disinfecting effective amount of a composition according to claim 9 for a sufficient time to sanitize said surface.

21. A composition according to claim 1 characterized in that:
the compositions exhibit germicidal efficacy against Gram positive bacteria on hard surfaces.

22. A composition according to claim 1 characterized in that:
the compositions exhibit germicidal efficacy against Gram negative bacteria on hard surfaces.

23. The composition according to claim 1 characterized in that:
the compositions provide at least a 2 log10 reduction of Salmonella choleraesuis using a Biomek assay at a 15 second contact time.

24. (canceled)

25. A composition according to claim 1 characterized in that:
the compositions exhibit blooming when diluted in water at a ratio of 1 part of the composition to 10 to 100 parts of water.
